(19) United States
(12) Patent Application Publication
(10) Pub. No.: US 2021/0201459 A1
(43) Pub. Date: Jul. 1, 2021

(54) System and Method for Detecting Abnormal Particles

(71) Applicant: One Tech, Inc., Dallas, TX (US)

(72) Inventors: Gema Almoguera, Irving, TX (US); Yasser Khan, Dallas, TX (US); Yandong Zhang, Plano, TX (US); Levi Davis, Dallas, TX (US)

(21) Appl. No.: 16/728,894

(22) Filed: Dec. 27, 2019

(51) Int. Cl. G06T 7/00; G06T 5/00; B25J 9/16

(52) U.S. Cl. CPC G06T 7/001; G06T 5/003; G06T 2207/20081; G06T 2207/30242; B25J 9/1697

(57) ABSTRACT

The present disclosure provides a system and method for detecting abnormal particles. The system includes a tray used to hold and display multiple particles, a manipulating device used to manipulate the tray and the particles thereon, an imaging element capable of capturing an image of the tray, and an image processor capable of determining the quantity, shape, and size of particles on the tray as displayed by the images captured by the imaging element and analyzing the images. The image processor comprises an image data processor, a memory, and an output command processor.

### CROSS REFERENCE TO RELATED APPLICATIONS

### Background

Particles are used in countless industries including manufacturing, pharmaceutics, agriculture, construction, diagnostics, and scientific applications. The sortation of particles is critical for each of these industries, which rely on the use of particles with specific physical characteristics. There are various systems and methods for the separation and sortation of particles, but the systems and methods are only as valuable as their ability to recognize the unique physical characteristics of each particle. For example, if a system is designed to separate square particles from round particles, the ability to detect the shape of each particle is critical to the sortation system.

Image processing systems are computerized systems designed to process data generated from digital images of an object or objects. The processing of images, performed within image processing systems, is a useful tool in assessing the physical characteristics of particles and other objects. Further, image processing systems may be used to detect physical characteristics that are critical to the control of objects, including the sorting of objects such as particles, making it an important asset in quality control mechanisms. For example, a product composed of several particles may require quality control to ensure that each particle meets specific physical requirements (e.g., size or shape requirements). A system designed to assess the physical characteristics of objects and to identify physical abnormalities of those objects is critical to maintaining the quality of the overall product.

Due to anomalies in manufacturing, manufactured particles may feature undesirable physical characteristics. It is useful to a have a method of identifying abnormal or undesirable particles. The same is true for particles grown agriculturally (e.g., soy beans). Abnormal or undesirable particles must be properly identified so that they may be sorted accordingly. There is at least several problems with current image processing systems used in processing images of particles: (1) they are incapable of detecting conjoined particles; and (2) they are incapable of ensuring that the analyzed images of the particles show each particle without inaccurately recognizing separate particles as conjoined particles. Conjoined particles are particles that are not fully separated. The current state of the art does not allow a system to decipher the difference between conjoined particles and separate particles that are touching each other. There are many applications in which a conjoined particle is less desirable than an ordinary (separate) particle. The identification of conjoined particles requires an improved image processing system.

For the foregoing reasons, there is a need for a system and method for detecting abnormal particles. The system and method disclosed herein solve problems encountered with detecting conjoined, or otherwise abnormal particles.

### SUMMARY

As disclosed and described herein, in one aspect thereof, includes a system and method for detecting abnormal particles. The system includes a tray used to hold and display a multitude of particles, a manipulating device used to manipulate the tray and the particles thereon, an imaging element capable of capturing an image of the multitude of particles, and an image processor capable of determining the quantity, shape, and size of particles on the tray as displayed by the images captured by the imaging element. The image processor comprises an image data processor, a memory, and an output command processor.

The tray is loaded with multiple particles through a loading mechanism. The manipulating device may manipulate the tray or the particles, thus further distributing the particles on the tray. The imaging element captures an initial image of the particles on the tray. An image processor features an image data processor which analyzes the image data for the initial image to determine the number of particles on the tray. A memory stores the image data including the number of particles on the tray. The image processor also features an output command processor which commands the manipulating device to manipulate the tray or the particles. The output command processor also directs the imaging element to capture additional images of the particles on the tray. The image data processor analyzes the additional images to determine the number of particles on the tray. The memory stores the image data for the additional images including the number of particles on the tray. The image processor determines the maximum number of particles on the tray, based on the number of particles shown in the initial image and the additional images. The memory records the maximum number of particles on the tray as shown in the initial image and the additional images. The image processor thus controls the iterative process of manipulating the tray and the particles thereon and collecting image data to determine the maximum number of particles on the tray, based on a series of images captured by the imaging element and processed by the image processor. The image processor repeats the steps until the maximum number of particles remains constant. The image data processor may use the image or images with the maximum number of particles to perform an analysis of the physical attributes of the particles.

### BRIEF DESCRIPTION OF THE DRAWINGS

These and other features, aspects, and advantages of the present disclosure will become better understood with regard to the following description, appended claims, and accompanying drawings where:

FIG. 1 is a flowchart illustrating a method of detecting a maximum number of particles, and describing the iterative algorithm used, wherein the steps are repeated a fixed number of times.

FIG. 2 is a flowchart illustrating a method of detecting a maximum number of particles, and describing the iterative algorithm used, wherein the steps are repeated until no new maximum number of particles is found.

FIG. 3A is a depiction of a batch of singular particles.

FIG. 3B is an exemplary histogram showing the distribution of particle size for each particle in an exemplary batch of singular particles.

FIG. 4A is a depiction of a batch of particles containing both singular particles and conjoined particles.

FIG. 4B is an exemplary histogram showing the distribution of particle size for each particle in an exemplary batch of both singular particles and conjoined particles.

FIG. 5A is a depiction of a batch of conjoined particles.

FIG. 5B is an exemplary histogram showing the distribution of particle size for each particle in an exemplary batch of conjoined particles.

### DESCRIPTION OF THE PREFERRED EMBODIMENTS

The present invention can be better understood by the following discussion of the application of certain preferred embodiments. Like reference numerals are used to describe like parts in all figures of the drawings.

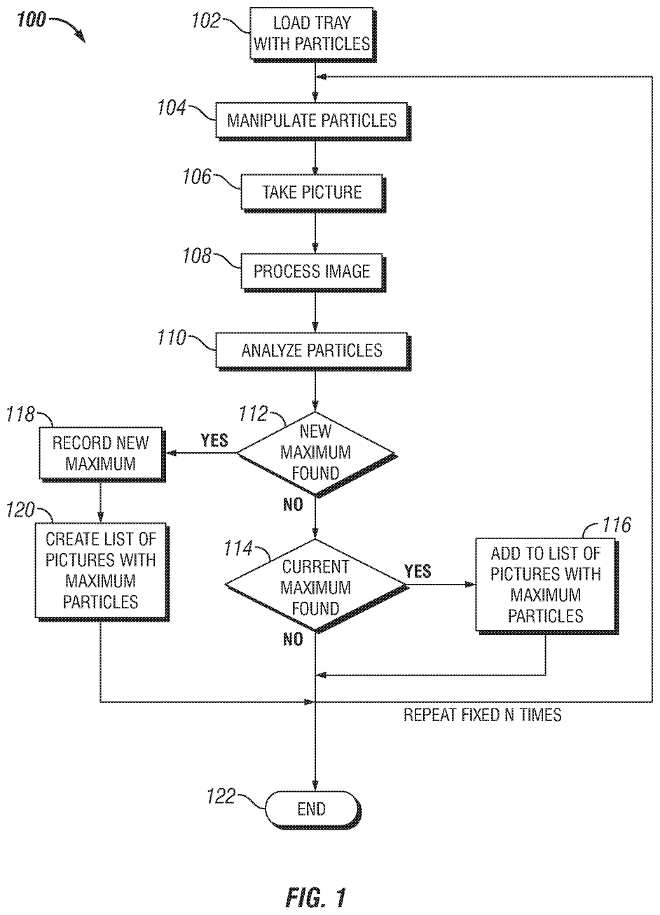

FIG. 1 is a flowchart illustrating a method of detecting a maximum number of particles, and describing the iterative algorithm used. The method for detecting abnormal particles begins with loading a tray with particles in a step 102. The step 102 comprising loading the tray with particles may be done by an operator or an automated loading process. The automated loading process may be controlled remotely. An output command processor commands a manipulating device to perform the manipulation step 104 of manipulating the particles. The manipulation step 104 may be done by manipulating the tray, such that the particles are physically displaced. For example, the manipulating device may shake the tray in order to evenly distribute the particle within the tray. The manipulation step 104 may also be done by manipulating the particles directly. For example, the manipulating device may physically shift the particles on top of the tray through direct contact with the particles in order to evenly distribute the particles on top of the tray. One such manipulating device may be a robotic arm. Next, in an imaging step 106, an imaging element takes a picture of the particles on top of the tray. One such imaging element may be a digital camera. In a next image data processing step 108, an image data processor then processes the image. The image data processing step 108 may include sharpening the details in the image. Next, in an analysis step 110, the image data processor then analyzes the particles in the image. The analysis step 110 may include determining the number of particles in the image. In a determination step 112, the image data processor then determines whether there is a new maximum number of particles on the tray based on the image. In a first iteration of the process, the first determination of the number of particles in the image yields a maximum number of particles on the tray. In a step 118, a memory records the new maximum number of particles on the tray. In a step 120, the memory creates a list of pictures with maximum number of particles. This may result in the end of the process of detecting abnormal particles after a first iteration. In one preferred embodiment, the process repeats n times. The step 104 is repeated and the output command processor commands the manipulating device to again manipulate the particles. The step 106 is also repeated and the output command processor commands the imaging element to take another picture. The steps are repeated a fixed number of times. In the determination step 112, if a new maximum is not found, the algorithm proceeds to a determination step 114 to determine if a current maximum is found. In the determination step 114, if a current maximum is found, in a next step 116, memory adds to the list of pictures with maximum particles. In the determination step 114, if a current maximum is not found, the method may end or repeat a fixed number of times.

One example of the method described in FIG. 1 may be described as follows: In step 102, an operator first loads a tray with a collection of seeds. In step 104, a robotic arm manipulates the seeds by shaking the tray, thus further distributing the seeds on the tray. Next, in step 106, a digital imaging device takes a picture of the seeds on the tray. In step 108, an image data processor processes the image by sharpening the image. In step 110, the image data processor analyzes the image. During step 110, the image data processor may determine the number of seeds pictured in the tray. The image data processor may also determine the physical features of the seeds pictured. In the determination step, step 112, the image data processor determines the number of seeds on the tray based on the image, thus finding a first maximum number of seeds on the tray. In step 118, a memory records the maximum number of seeds in the image and then creates a list of pictures with the maximum number of seeds, in step 120. The process then repeats, beginning at step 104, wherein the robotic arm manipulates the seeds by shaking the tray. In step 106, the digital imaging device takes a picture of the seeds and in step 108, the image data processor sharpens the new image. In step 110, the image data processor analyzes the image to determine the number of seeds pictured on the tray, along with determining the physical features of the seeds pictured. Next, in step 112, the image data processor determines whether there is a new maximum number of seeds based on the current number of seeds shown in the image. If there is a new maximum found, a memory records the new maximum, step 118, and updates the list of pictures with the maximum seeds, step 120. The process repeats a fixed number of times, based on user preference. After the fixed number of times, the system takes its current maximum number of seeds, step 113, and adds the image corresponding to the current maximum to the list of pictures in step 116.

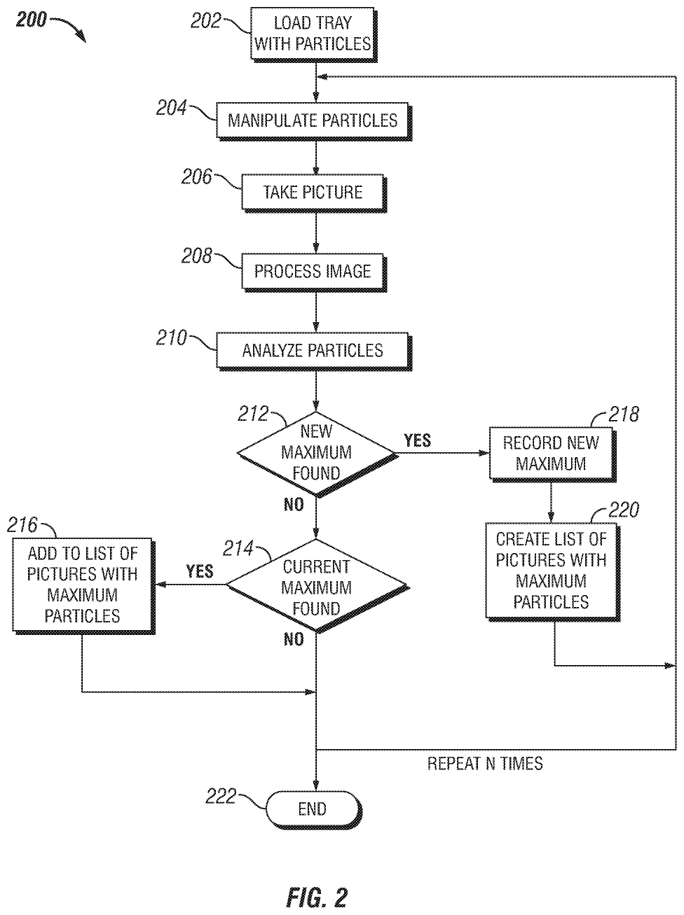

FIG. 2 is a flowchart illustrating an alternative method of detecting a maximum number of particles, and describing the iterative algorithm used. Similarly, as illustrated in FIG. 1, the method of detecting abnormal particles begins with step 202 loading a tray with particles. The step 202 comprising loading a tray with particles may be done by an operator or an automated loading process. The automated loading process may be controlled remotely. An output command processor commands a manipulating device to perform the step 204 of manipulating the particles. The manipulation step 204 may be done by manipulating the tray, such that the particles are physically displaced. For example, the manipulating device may shake the tray in order to evenly distribute the particle on top of the tray. The manipulation step 204 may also be done by manipulating the particles directly. For example, the manipulating device may physically shift the particles on top of the tray through direct contact with the particles in order to evenly distribute the particles on top of the tray. One such manipulating device may be a robotic arm. Next, in an imaging step 206, an imaging element takes a picture of the particles on top of the tray. One such imaging element may be a digital camera. In a next image data processing step 208, an image data processor then processes the image. The image data processing step 208 may include sharpening the details in the image. Next, in an analysis step 210, the image data processor then analyzes the particles in the image. The analysis step 210 may include determining the number of particles in the image. In a determination step 212, the image data processor then determines a new maximum number of particles on the tray based on the image. In a first iteration of the process, the first determination of the number of particles in the image yields a maximum number of particles on the tray. In a step 218, a memory records the new maximum number of particles on the tray 218. In a step 220, the memory creates a list of pictures with maximum number of particles. The step 204 is repeated and the output command processor commands the manipulating device to again manipulate the particles. The step 206 is also repeated and the output command processor commands the imaging element to take another picture. The steps are repeated iteratively. In the determination step 212, if a new maximum is found, in a step 218, the memory records the new maximum number of particles on the tray. In a step 220, the memory creates a list of pictures with maximum particles 220 and the iterative process repeats. In the determination step 212, if a new maximum is not found and in a next determination step 214, a current maximum is found, in a step 216, the memory adds to the list of pictures with maximum particles. In a preferred embodiment, the method repeats iteratively until no new maximum is found in the determination step 212 after several iterations.

One example of the method described in FIG. 2 may be described as follows: In step 202, an operator first loads a tray with a collection of grains. In step 204, a robotic arm manipulates the grains by shaking the tray, thus further distributing the grains on the tray. Next, in step 206, a digital imaging device takes a picture of the grains on the tray. In step 208, an image data processor processes the image by sharpening the image. In step 210, the image data processor analyzes the image. During the step, the image data processor may determine the number of grains pictured in the tray. The image data processor may also determine the physical features of the grains pictured. In the determination step, step 212, the image data processor determines the number of grains on the tray based on the image, thus finding a first maximum number of grains on the tray. In step 218, a memory records the maximum number of grains in the image and then creates a list of pictures with the maximum number of grains, in step 220. The process then repeats, beginning at step 204, wherein the robotic arm manipulates the grains by shaking the tray. In step 206, the digital imaging device takes a picture of the grains and in step 208, the image data processor sharpens the new image. In step 210, the image data processor analyzes the image to determine the number of grains pictured on the tray, along with determining the physical features of the grains pictured. Next, in step 212, the image data processor determines whether there is a new maximum number of grains based on the current number of grains shown in the image. If there is a new maximum found, a memory records the new maximum, step 218, and updates the list of pictures with the maximum grains in step 220. The process repeats n number of times. In this example, the iterations may stop after there are no new maximum numbers of seeds.

Because the memory has stored a list of pictures with maximum particles in the step 220, the image data processor may use an image with the maximum number of particles to perform further image analysis. For example, an image with the maximum number of particles may be used to analyze the physical attributes of the individual particles as this image will provide the best view of each individual particle.

The system and method described in FIG. 2 may effectively be used to find abnormalities in particles. In the analysis step 210, the system may determine the number of particles in the image. The image data processor may also analyze the physical characteristics of each particle. For example, the image data processor may manually employ physical attribute analysis to determine the size and shape of each individual particle. The image data processor may also compare the physical attributes of multiple particles in the analysis step 210. This data may be stored in the memory.

It is another object of this invention to employ deep learning to perform analysis of the particles. The image data processor may be trained to identify abnormal particles. The training may include providing a large dataset of pictures from a database to the image data processor, with the images classified as containing abnormal or normal particles, based on the physical attributes critical to the application. The image data processor may then use the training data to classify imaged particles as normal or abnormal using its learned identification parameters.

It is another object of this invention to track the average size or shape of the particles on the tray, which may be considered “normal” for purposes of completing a density analysis. The image data processor may complete this density analysis by comparing the other particles to the “normal” particle size in order to determine which particles are likely conjoined particles based on size.

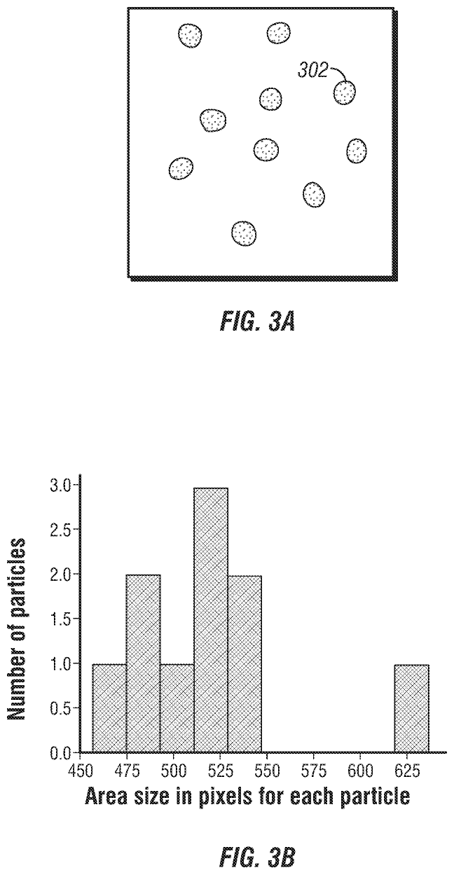

FIG. 3A is a depiction of a batch of singular particles. There are no conjoined particles within the batch and the particles all appear to be of similar size.

FIG. 3B is an exemplary histogram showing the distribution of particle size for each particle in an exemplary batch of singular particles. The area size in pixels varies between 456 pixels and 637 pixels.

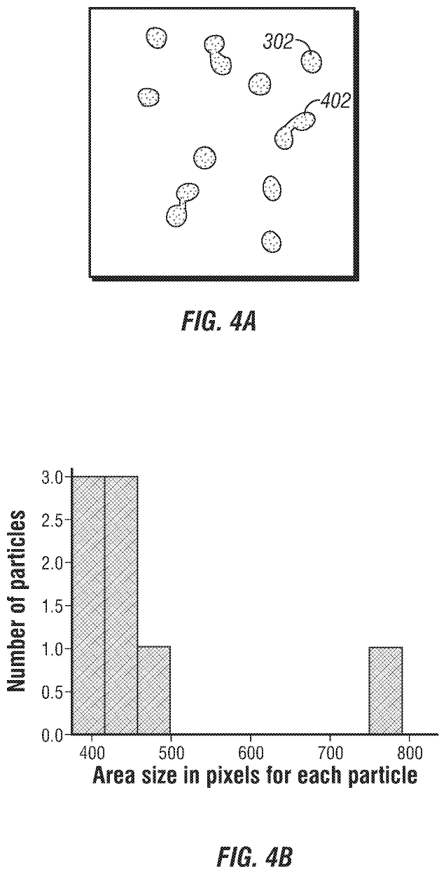

FIG. 4A is a depiction of a batch of particles containing both singular particles and conjoined particles. Methods known in the art for detecting abnormal particles could mistakenly confuse conjoined particles for singular particles that are touching each other and not conjoined. One object of the present invention is to determine an accurate number of particles in a batch. This requires a method to ensure that singular particles that are touching each other are not counted as a single conjoined particle. The steps illustrated in FIGS. 1 and 2 ensure that the particles may be spread, distributed, and accurately counted in the series of steps in the described methods.

FIG. 4B is an exemplary histogram showing the distribution of particle size for each particle in an exemplary batch of both singular particles and conjoined particles. The area size in pixels varies between 375 pixels and 792 pixels. The variation in particle size illustrates that some particles are nearly double the size of others, which suggests that the batch includes singular particles and particles that are conjoined.

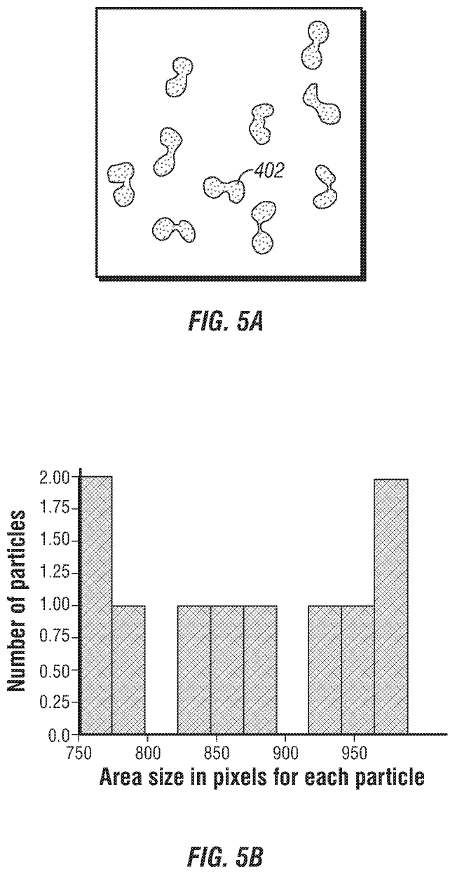

FIG. 5A is a depiction of a batch of particles containing only conjoined particles.

FIG. 5B is an exemplary histogram showing the distribution of particle size for each particle in an exemplary batch of conjoined particles. The area size in pixels varies between 754 pixels and 986 pixels. The variation in particle size illustrates that some particles are of similar size.

Unless otherwise specifically stated, the terms and expressions have been used herein as terms of description and not terms of limitation. There is no intention to use the terms or expressions to exclude any equivalent of features shown and described or portions thereof and this invention should be defined in accordance with the claims that follow.

What is claimed is:

1. A system for detecting abnormal particles, comprising:
a tray, wherein the tray is configured to hold and display a multitude of particles;
a manipulating device configured to:
manipulate the tray;
manipulate the multitude of particles; or
a combination thereof;
an imaging element, wherein the imaging element is capable of capturing an image of the multitude of particles; and
an image processor comprising:
an image data processor, wherein the image data processor is configured to:
process the image; and
analyze the multitude of particles in the image;
a memory; and
an output command processor, configured to:
command the manipulating device to manipulate the tray;
command the manipulating device to manipulate the multitude of particles;
command the imaging element to capture an image of the multitude of particles; or
a combination thereof.

2. The system of claim 1, wherein the output command processor is configured to perform one or more of the following steps a fixed number of times: command the manipulating device to manipulate the tray; command the manipulating device to manipulate the multitude of particles; command the imaging element to capture an image of the multitude of particles.

3. The system of claim 1, wherein the multitude of particles are loaded onto the tray using an automated loading process.

4. The system of claim 3, wherein the automated loading process may be controlled remotely.

5. The system of claim 1, wherein the manipulating device is a robotic arm.

6. The system of claim 1, wherein image data processor is configured to sharpen the details in the image.

7. The system of claim 1, wherein the image data processor is configured to determine the number of particles in the multitude of particles.

8. The system of claim 1, wherein the image data processor is configured to determine the maximum number of particles in the multitude of particles.

9. The system of claim 8, wherein the output command processor is configured to perform the following steps until the image data processor determines that there is no new maximum number of particles in the multitude of particles: command the manipulating device to manipulate the tray; command the manipulating device to manipulate the multitude of particles; command the imaging element to capture an image of the multitude of particles.

10. The system of claim 1, wherein the image data processor is configured to detect the physical characteristics of a particle in the multitude of particles.

11. The system of claim 10, wherein the image data processor is configured to compare physical characteristics of a particle in the multitude of particles to the physical characteristics of another particle in the multitude of particles.

12. The system of claim 7, wherein the memory is configured to store the number of particles in the multitude of particles in the image.

13. The system of claim 10, wherein the memory is configured to store the detected physical characteristics of a particle in the multitude of particles.

14. The system of claim 8, wherein the memory is configured to store the images with the maximum number of particles in the multitude of particles.

15. The system of claim 14, wherein the image data processor is configured to use an image with the maximum number of particles in the multitude of particles to analyze the multitude of particles in the image.

16. The system of claim 1, wherein the image data processor is configured to be trained by a remote processor, wherein the remote processor provides a set of training data from a database comprised of a large dataset of exemplary images identified as normal particles or abnormal particles to the image data processor.

17. The system of claim 16, wherein the image data processor is configured to use the set of training data to identify normal and abnormal particles in the multitude of particles.

18. A method for detecting abnormal particles comprising:
holding and displaying a multitude of particles on a tray;
manipulating the multitude of particles using a manipulating device;
capturing an image of the multitude of particles using an imaging element;
processing the image of the multitude of particles using an image data processor;
analyzing the multitude of particles in the image using the image data processor;
generating image data using the image data processor;
storing the image and the image data in a memory;
commanding the manipulating device to manipulate the multitude of particles using an output command processor; and
commanding the imaging element to capture an image of the multitude of particles using the output command processor.

19. The method of claim 18, wherein the output command processor is configured to perform one or more of the following steps a fixed number of times: command the manipulating device to manipulate the tray; command the manipulating device to manipulate the multitude of particles; command the imaging element to capture an image of the multitude of particles.

20. The method of claim 18, wherein the manipulating device is a robotic arm.

21. The method of claim 18, wherein image data processor is configured to sharpen the details in the image.

22. The method of claim 18, wherein the image data processor is configured to determine the number of particles in the multitude of particles.

23. The method of claim 22, wherein the image data processor is configured to determine the maximum number of particles in the multitude of particles.

24. The method of claim 23, wherein the output command processor is configured to perform the following steps until the image data processor determines that there is no new maximum number of particles in the multitude of particles: command the manipulating device to manipulate the tray; command the manipulating device to manipulate the multitude of particles; command the imaging element to capture an image of the multitude of particles.

25. The method of claim 18, wherein the image data processor is configured to detect the physical characteristics of a particle in the multitude of particles.

26. The method of claim 25, wherein the image data processor is configured to compare physical characteristics of a particle in the multitude of particles to the physical characteristics of another particle in the multitude of particles.

27. The method of claim 22, wherein the memory is configured to store the number of particles in the multitude of particles in the image.

28. The method of claim 25, wherein the memory is configured to store the detected physical characteristics of a particle in the multitude of particles.

29. The method of claim 23, wherein the memory is configured to store the images with the maximum number of particles in the multitude of particles.

30. The method of claim 29, wherein the image data processor is configured to use an image with the maximum number of particles in the multitude of particles to analyze the multitude of particles in the image.

31. The method of claim 18, wherein the image data processor is configured to be trained by a remote processor, wherein the remote processor provides a set of training data from a database comprised of a large dataset of exemplary images identified as normal particles or abnormal particles to the image data processor.

32. The method of claim 31, wherein the image data processor is configured to use the set of training data to identify normal and abnormal particles in the multitude of particles.
